(19) United States
(12) Patent Application Publication
(10) Pub. No.: US 2024/0061084 A1
(43) Pub. Date: Feb. 22, 2024

(54) DRIVER CHIP, PACKAGING METHOD FOR OPTICAL FILTER STRUCTURE, OPTICAL SENSOR DEVICE AND PACKAGING METHOD THEREOF

(71) Applicant: OIP Technology Pte Ltd, Singapore (SG)

(72) Inventors: Deze YU, Singapore (SG); Wanning ZHANG, Singapore (SG)

(21) Appl. No.: 17/892,348

(22) Filed: Aug. 22, 2022

(51) Int. Cl. G01S 7/481

(52) U.S. Cl. CPC G01S 7/4816; G01S 7/4814; G02B 5/20

(57) ABSTRACT

A driver chip, a packaging method for optical filter structure, an optical sensor device and a packaging method for optical sensor device are disclosed. The packaging method for optical filter structure includes providing first carrier substrate, one side of first carrier substrate provided with first adhesive layer; placing at least one first optical filter and at least one second optical filter on first adhesive layer in such a manner that first and second optical filters are spaced apart from each other; filling plastic encapsulation material between first and second optical filters and curing plastic encapsulation material to form a first plastic encapsulation layer. Opposing sides of the first optical filter and opposing sides of the second optical filter are exposed from the first plastic encapsulation layer; and removing the first carrier substrate. In this way, optical sensor device is allowed to have a reduced size, which results in space savings.

### CROSS-REFERENCES TO RELATED APPLICATION

This application claims the priority of Chinese patent application number 202210752193.0, filed on Jun. 28, 2022, the entire contents of which are incorporated herein by reference.

### TECHNICAL FIELD

The present invention relates to the field of optical sensor design and fabrication technology and, in particular, to an optical filter structure and a packaging method thereof, as well as to an optical sensor device and a packaging method thereof.

### BACKGROUND

Existing photoelectric sensors include a chip, which is detection of light signal and a light source, both on a PCB. The chip can be a photo diode or photo diode plus driver IC and the light source are bonded with metal wires and covered with a cover that confines the chip and the light source between the PCB and the cover. An optical filter is provided on the cover, leaving a gap between the light source and the optical filter. This structure is limited in terms of miniaturization.

### SUMMARY

It is an object of the present invention to provide a driver chip, a packaging method for optical filter structure, an optical sensor device and a packaging method for optical sensor device. The optical sensor device has a reduced size and is space-saving. To this end, in a first aspect of the present invention, there is provided a packaging method for an optical filter structure, including the steps of: providing a first carrier substrate, one side of the first carrier substrate being provided with a first adhesive layer; placing at least one first optical filter and at least one second optical filter on the first adhesive layer in such a manner that the first optical filter and the second optical filter are spaced apart from each other; filling a plastic encapsulation material between the first optical filter and the second optical filter and curing the plastic encapsulation material to form a first plastic encapsulation layer, wherein opposing sides of the first optical filter and opposing sides of the second optical filter are exposed from the first plastic encapsulation layer; and removing the first carrier substrate.

In a second aspect of the present invention, there is provided a driver chip, configured to be embedded in a second plastic encapsulation layer, the second plastic encapsulation layer provided on a front side thereof with a first structure, the driver chip including a main body, an input/output port and a photosensitive member; the input/output port and the photosensitive member disposed on a same side, and spaced apart from each other on the main body, the main body disposed close to a back side of the second plastic encapsulation layer, both the input/output port and the photosensitive member disposed close to the front side of the second plastic encapsulation layer; wherein the input/output port and the photosensitive member in the driver chip are exposed from the front side of the second plastic encapsulation layer, thereby enabling the first structure to be electrically connected on the front side of the second plastic encapsulation layer to the input/output port.

In a third aspect of the present invention, there is provided an optical sensor device, including a light-emitting module and an optical filter structure,
the light-emitting module including a second plastic encapsulation layer, a light-emitting unit and a driver chip, the light-emitting unit and the driver chip both embedded in the second plastic encapsulation layer so as to be spaced apart from each other, each of the second plastic encapsulation layer, the light-emitting unit and the driver chip having a front side and a back side, the front sides of the second plastic encapsulation layer, the light-emitting unit and the driver chip facing the same direction, the driver chip provided on the front side thereof with a photosensitive member, the light-emitting unit provided on the front side thereof with a light exit region, the front and back sides of the light-emitting unit and the front side of the driver chip exposed from the second plastic encapsulation layer, the second plastic encapsulation layer provided therein with a plurality of through holes, which extend in a thickness direction through the second plastic encapsulation layer, and in which a conductive material is filled, the second plastic encapsulation layer provided on the front side thereof with a first structure, the first structure electrically connected on the front side of the second plastic encapsulation layer to the conductive material in the through holes and to the light-emitting unit and the driver chip, the second plastic encapsulation layer provided on the back side thereof with a second structure, the second structure electrically connected on the back side of the second plastic encapsulation layer to the conductive material in the through holes and to the light-emitting unit, the optical filter structure bonded to a front side of the light-emitting module and including a first plastic encapsulation layer, a first optical filter and a second optical filter, the first optical filter and the second optical filter both embedded in the first plastic encapsulation layer so as to be spaced apart from each other, opposing sides of the first optical filter and opposing sides of the second optical filter exposed from the first plastic encapsulation layer, the second optical filter disposed above the light exit region and configured to filter light emanated from the light-emitting unit, the first optical filter disposed above the photosensitive member and configured to filter emitted light that is reflected by an object to the driver chip.

Optionally, the first optical filter and the second optical filter have different shapes and/or sizes with respect to a direction perpendicular to a thickness direction of the first plastic encapsulation layer.

Optionally, the second plastic encapsulation layer has a thickness equal to the thinnest thickness of the light-emitting unit and the driver chip.

Optionally, the light-emitting unit may include a light-emitting device and an electrical conduction element, the electrical conduction element electrically connected to the light-emitting device, the light-emitting device disposed close to the front side of the second plastic encapsulation layer, the electrical conduction element disposed close to the back side of the second plastic encapsulation layer.

Additionally, the light-emitting device may be an LED (Light-emitting diode) or a VCSEL (Vertical Cavity Surface-emitting Lasers).

Additionally, at least part of a surface of the light-emitting device close to the front side of the second plastic encapsulation layer may be exposed from the front side of the second plastic encapsulation layer, with at least part of a surface of the electrical conduction element close to the back side of the second plastic encapsulation layer being exposed from the back side of the second plastic encapsulation layer, thereby enabling the first structure to be electrically connected on the front side of the second plastic encapsulation layer to the light-emitting device and enabling the second structure to be electrically connected on the back side of the second plastic encapsulation layer to the electrical conduction element.

Additionally, the light-emitting device may include a light-emitting body, a first electrode, a second electrode and a light exit region, the first electrode disposed close to the back side of the second plastic encapsulation layer, the second electrode and the light exit region both disposed close to the front side of the second plastic encapsulation layer.

Additionally, the second electrode and the light exit region may be exposed from the front side of the second plastic encapsulation layer, thereby enabling the first structure to be electrically connected on the front side of the second plastic encapsulation layer to the second electrode.

Optionally, the electrical conduction element is electrically connected to the light-emitting device vertically by silver paste, thereby improving heat dissipation to the back side of the second plastic encapsulation layer.

Optionally, the silver paste has a thickness of 50 μm.

Optionally, the first structure may include a first passivation layer, a first metal layer and a second passivation layer, which are formed over the front side of the second plastic encapsulation layer sequentially in this order, the first passivation layer covering the front side of the second plastic encapsulation layer and the front side of the driver chip in such a manner that the input/output port and the photosensitive member in the driver chip, the second electrode and the light exit region in the light-emitting unit and part of the front side of the second plastic encapsulation layer are exposed therefrom and that the conductive material in the through holes are exposed from the front side of the second plastic encapsulation layer, the first metal layer including a plurality of first bonding pads, which are located on parts of the first passivation layer and are electrically connected to the input/output port, the conductive material in the through holes and the second electrode in the light-emitting unit, the second passivation layer covering the first passivation layer and the first metal layer in such a manner that the photosensitive member and the light exit region are exposed from the second passivation layer.

Optionally, the second structure may include a third passivation layer, a second metal layer and a fourth passivation layer, which are formed over the back side of the second plastic encapsulation layer sequentially in this order, the third passivation layer covering the back side of the second plastic encapsulation layer and the back side of the driver chip in such a manner that the back side of the light-emitting unit is exposed therefrom and that the conductive material in the through holes is exposed from the back side of the second plastic encapsulation layer, the second metal layer including a plurality of second bonding pads, which are located on parts of the third passivation layer and are electrically connected to the conductive material in the through holes and the electrical conduction element in the light-emitting unit, the fourth passivation layer covering the third passivation layer and the second metal layer, the fourth passivation layer provided therein with at least two connecting holes in which the second metal layer is exposed, the connecting holes filled with a conductive material, the conductive material in the connecting holes configured to be electrically connected to an external circuit.

In a fourth aspect of the present invention, there is provided a packaging method for the optical sensor device, including the steps of:
providing a first carrier substrate and a second carrier substrate, the first carrier substrate provided on one side thereof with a first adhesive layer, the second carrier substrate provided on one side thereof with a second adhesive layer;
placing at least one of the first optical filter and at least one of the second optical filter on the first adhesive layer in such a manner that they are spaced apart from each other and placing at least one of the light-emitting unit and at least one of the driver chip on the second adhesive layer in such a manner that they are spaced apart from each other, wherein each of the light-emitting unit and the driver chip has a front side and an opposing back side, wherein the front sides of the light-emitting unit and the driver chip are disposed on the same side and both face the second adhesive layer, and wherein the light-emitting unit is provided on the front side thereof with the light exit region and the driver chip is provided on the front side thereof with the photosensitive member;
filling a plastic encapsulation material between the first optical filter and the second optical filter, curing the plastic encapsulation material to form the first plastic encapsulation layer, filling a plastic encapsulation material between the light-emitting unit and the driver chip and curing the plastic encapsulation material to form the second plastic encapsulation layer, wherein the second plastic encapsulation layer has a front side and an opposing back side, wherein the front sides of the second plastic encapsulation layer, the light-emitting unit and the front side are disposed on the same side, and wherein the front and back sides of the light-emitting unit and the front side of the driver chip are exposed from the second plastic encapsulation layer;
removing the first carrier substrate and the second carrier substrate;
forming, on the back side of the second plastic encapsulation layer, the second structure electrically connected on the back side of the second plastic encapsulation layer to both the conductive material in the through holes and the light-emitting unit, forming, in the second plastic encapsulation layer, the plurality of through holes extending through the second plastic encapsulation layer in the thickness direction thereof, filling the conductive material in the through holes, and forming, on the front side of the second plastic encapsulation layer, the first structure electrically connected on the front side of the second plastic encapsulation layer to the conductive material in the through holes, the light-emitting unit and the driver chip; and
bonding the first plastic encapsulation layer to the front side of the second plastic encapsulation layer in such a manner that the photosensitive member is located under the first optical filter and the light exit region under the second optical filter.

Compared with the prior art, the present invention has the benefits as follows:

The present invention provides an optical filter structure, a packaging method for the optical filter structure, an optical sensor device and a packaging method for the optical sensor device. The optical filter structure includes a first plastic encapsulation layer, a first optical filter and a second optical filter. The first optical filter and the second optical filter are both embedded in the first plastic encapsulation layer and spaced apart from each other. Opposing sides of the first optical filter and opposing sides of the second optical filter are exposed from the first plastic encapsulation layer. According to the present invention, the embedded optical filters in the optical filter structure enable the optical sensor device to have a reduced size, resulting in space savings.

Further, the optical sensor device of the present invention includes a light-emitting module and an optical filter structure. The light-emitting module includes a second plastic encapsulation layer, a light-emitting unit and a driver chip. The light-emitting unit and the driver chip are both embedded in the second plastic encapsulation layer so as to be spaced apart from each other. Each of the second plastic encapsulation layer, the light-emitting unit and the driver chip has a front side and a back side, and the front sides of the second plastic encapsulation layer, the light-emitting unit and the driver chip face the same direction. The driver chip is provided on the front side thereof with a photosensitive member, and the light-emitting unit is provided on the front side thereof with a light exit region. The front and back sides of the light-emitting unit and the front side of the driver chip are exposed from the second plastic encapsulation layer. The second plastic encapsulation layer is provided therein with a plurality of through holes, which extend in a thickness direction through the second plastic encapsulation layer, and in which a conductive material is filled. The second plastic encapsulation layer is provided on the front side thereof with a first structure electrically connected on the front side of the second plastic encapsulation layer to the conductive material in the through holes and to the light-emitting unit and the driver chip. The second plastic encapsulation layer is provided on the back side thereof with a second structure electrically connected on the back side of the second plastic encapsulation layer to the conductive material in the through holes and to the light-emitting unit. The optical filter structure is bonded to a front side of the light-emitting module and includes a first plastic encapsulation layer, a first optical filter and a second optical filter. The first optical filter and the second optical filter are both embedded in the first plastic encapsulation layer so as to be spaced apart from each other. Opposing sides of the first optical filter and opposing sides of the second optical filter are exposed from the first plastic encapsulation layer. The second optical filter is disposed above the light exit region and configured to filter light emanated from the light-emitting unit. The first optical filter is disposed above the photosensitive member and configured to filter emitted light that is reflected by an object to the driver chip. Thus, according to the present invention, through embedding the light-emitting unit and the driver chip in the second plastic encapsulation layer in the light-emitting module and forming the first structure, the second structure and the conductive material in the through holes on the second plastic encapsulation layer, the optical sensor device is allowed to have a further reduced size, which results in additional space savings.

### BRIEF DESCRIPTION OF THE DRAWINGS

FIG. 1 is a schematic diagram showing the structure of an optical sensor device according to an embodiment of present invention;

FIG. 2 is a schematic diagram showing the structure of a driver chip according to an embodiment of present invention;

FIG. 3 is a schematic diagram showing the structure of a light-emitting device according to an embodiment of present invention;

FIG. 4 is a schematic diagram showing the structure of an optical filter structure according to an embodiment of present invention; and

FIGS. 5a to 5d are schematic diagrams of structures formed in a method for packaging an optical sensor device according to an embodiment of present invention.

### DESCRIPTION OF REFERENCE NUMERALS IN DRAWINGS

110: Second Plastic Encapsulation Layer; 120: Driver Chip; 121: Main Body; 122: Input/Output Port; 123: Photosensitive Member; 130: Light-Emitting Device; 131: First Electrode; 132: Second Electrode; 133: Light Exit Region; 134: Light-Emitting Body; 140: Electrical Conduction Element; 150: Through Hole; 210: First Passivation Layer; 220: First Metal Layer; 230: Second Passivation Layer; 240: Third Passivation Layer; 250: Second Metal Layer; 260: Fourth Passivation Layer; 270: Connecting Hole; 310: First Plastic Encapsulation Layer; 320: First Optical Filter; 330: Second Optical Filter; 340: Adhesive.

### DETAILED DESCRIPTION

The optical filter structure, packaging method for the optical filter structure, optical sensor device and packaging method for the optical sensor device according to the present invention will be described in greater detail below. The present invention will be described in greater detail below with reference to the accompanying drawings, which present preferred embodiments of the invention. It would be appreciated that those skilled in the art can make changes to the invention disclosed herein while still obtaining the beneficial results thereof. Therefore, the following description shall be construed as being intended to be widely known by those skilled in the art rather than as limiting the invention.

For the sake of clarity, not all features of actual implementations are described in this specification. In the following, description and details of well-known functions and structures are omitted to avoid unnecessarily obscuring the invention. It should be appreciated that in the development of any such actual implementation, numerous implementation-specific decisions must be made to achieve specific goals of the developers, such as compliance with system-related and business-related constrains, which may vary from one implementation to another. Moreover, it should be appreciated that such a development effort might be complex and time consuming, but would nevertheless be a routine undertaking for those of ordinary skill in the art.

Objects and features of the present invention will become more apparent upon reading the following more detailed description thereof made with reference to the accompanying drawings and particular embodiments. Note that the figures are provided in a very simplified form not necessarily drawn to exact scale and for the only purpose of facilitating easy and clear description of the disclosed embodiments.

It is to be noted that, for the sake of simplicity and clarity, only one light-emitting unit and one driver chip are described herein and shown in schematic cross-sectional structural views.

FIG. 4 is a schematic diagram showing the structure of an optical filter structure according to an embodiment of the present invention. As shown in FIG. 4, the optical filter structure is adapted to filter out light signals of some wavelengths, such as visible light. The optical filter structure includes embedded optical filters. Specifically, the optical filter structure includes a first plastic encapsulation layer 310, a first optical filter 320 and a second optical filter 330. Both the first optical filter 320 and the second optical filter 330 are embedded in the first plastic encapsulation layer 310. Both the first optical filter 320 and the second optical filter 330 are spaced apart from each other. Each of the first optical filter 320 and the second optical filter 330 has a front side and an opposing back side. The front and back sides of the first optical filter 320 and the front and back sides of the second optical filter 330 are all exposed from the first plastic encapsulation layer 310. The first optical filter 320 and the second optical filter 330 have different shapes and/or sizes with respect to a direction perpendicular to a thickness direction of the first plastic encapsulation layer 310. In this embodiment, the embedded optical filters in the optical filter structure enable the optical sensor device to have a reduced size, resulting in space savings.

A packaging method for an optical filter structure according to an embodiment of the present invention includes the steps of:
providing a first carrier substrate, one surface of the first carrier substrate is formed with a first adhesive layer, wherein the first carrier substrate is, for example, square or circular in shape, and serves as a temporary carrier substrate;
placing at least one first optical filter and at least one second optical filter on the first adhesive layer in such a manner that they are spaced apart from each other;
filling a plastic encapsulation material between the first optical filter and the second optical filter and curing the plastic encapsulation material to form a first plastic encapsulation layer; and removing the first carrier substrate.

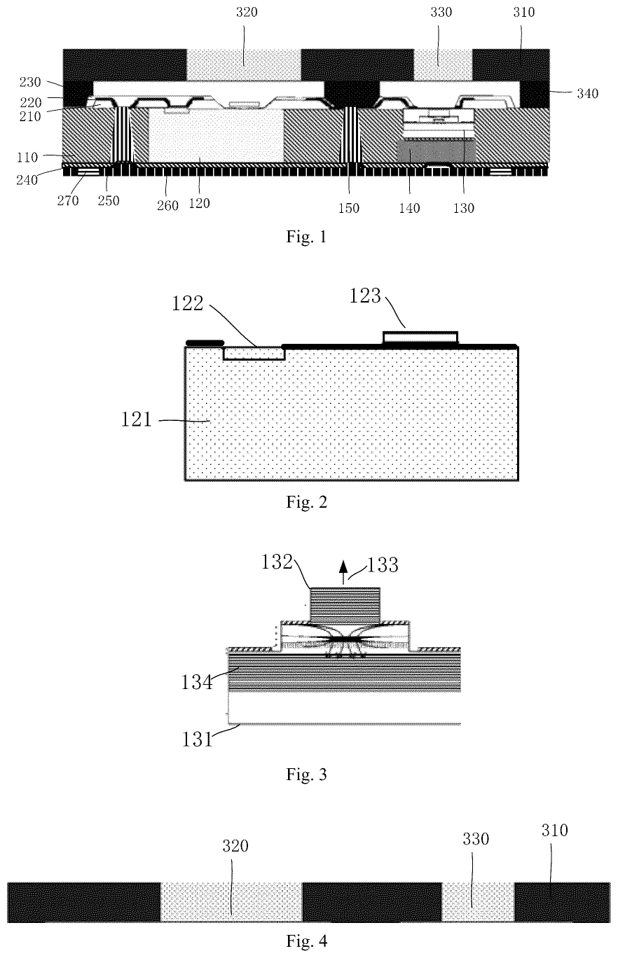

FIG. 1 is a schematic diagram showing the structure of an optical sensor device according to an embodiment of the present invention. As shown in FIG. 1, the optical sensor device according to this embodiment includes a light-emitting module and an optical filter structure secured to the light-emitting module. In particular, the optical filter structure may be adhesively attached to the light-emitting module.

The light-emitting module includes a second plastic encapsulation layer 110, a light-emitting unit and a driver chip 120. The light-emitting unit and the driver chip 120 are embedded in the second plastic encapsulation layer 110. The light-emitting unit and the driver chip 120 are spaced apart from each other. Each of the second plastic encapsulation layer 110, the light-emitting unit and the driver chip 120 have a front side and a back side. The back sides of the second plastic encapsulation layer 110, the light-emitting unit and the driver chip 120 face the same direction, and the front sides of the second plastic encapsulation layer 110, the light-emitting unit and the driver chip 120 also face the same direction. The front and back sides of the light-emitting unit and the front side of the driver chip 120 are exposed from the second plastic encapsulation layer 110. In this embodiment, in order to enable the light-emitting module to have minimized thickness, a thickness of the second plastic encapsulation layer 110 is equal to the thinnest thickness of the light-emitting unit and the driver chip 120. Since the thickness of the light-emitting unit may vary as required, the thickness of the second plastic encapsulation layer 110 may be configured to be equal to the thickness of the driver chip 120. In this case, the front and back sides of the driver chip 120 and the front and back sides of the light-emitting unit are exposed from the second plastic encapsulation layer 110.

FIG. 2 is a schematic diagram showing the structure of the driver chip according to an embodiment of the present invention. As shown in FIG. 2, in conjunction with FIG. 1, the driver chip 120 includes a main body 121, an input/output port 122 and a photosensitive member 123. The input/output port 122 and the photosensitive member 123 are disposed on the same side, and are spaced apart from each other on the main body 121. The main body 121 is disposed close to the back side of the second plastic encapsulation layer 110. Both the input/output port 122 and the photosensitive member 123 are disposed close to the front side of the second plastic encapsulation layer 110. The input/output port 122 and the photosensitive member 123 are exposed from the front side of the second plastic encapsulation layer 110. A surface of the main body 121 away from the photosensitive member 123 may be exposed from the back side of the second plastic encapsulation layer 110 or not. The photosensitive member 123 can receive a reflection of light from the light-emitting unit as a signal and provide the signal to the main body 121, which is adapted to issue various commands via the input/output port 122.

As shown in FIG. 1, the light-emitting unit includes a light-emitting device 130 and an electrical conduction element 140. The electrical conduction element 140 is electrically connected to the light-emitting device 130. The light-emitting device is disposed close to the front side of the second plastic encapsulation layer 110. The electrical conduction element 140 is disposed close to the back side of the second plastic encapsulation layer 110. At least part of a surface of the electrical conduction element 140 close to the back side of the second plastic encapsulation layer 110 is exposed from the back side of the second plastic encapsulation layer 110. At least part of a surface of the light-emitting device 130 close to the front side of the second plastic encapsulation layer 110 is exposed from the front side of the second plastic encapsulation layer. Additionally, silver paste applied between the electrical conduction element 140 and the light-emitting device 130 adhesively bonds the electrical conduction element 140 to the light-emitting device 130. In this way, the electrical conduction element 140 is electrically connected to the light-emitting device 130 vertically by the silver paste. Further, the electrical conduction element 140 provides a good heat dissipation effect.

FIG. 3 is a schematic diagram showing the structure of the light-emitting device according to an embodiment of the present invention. Referring to FIG. 3, in connection with FIG. 1, the light-emitting device 130 may be a light-emitting diode (LED), a vertical-cavity surface-emitting laser (VCSEL) or the like. The light-emitting device 130 is adapted to transmit a light signal at a particular wavelength. The light-emitting device 130 includes a light-emitting body 134, a first electrode 131, a second electrode 132 and a light exit region 133. The first electrode 131 is, for example, a cathode of the light-emitting unit and is disposed close to the back side of the second plastic encapsulation layer 110. The second electrode 132 and the light exit region 133 are both disposed close to the front side of the second plastic encapsulation layer 110. The second electrode 132 is, for example, an anode of the light-emitting unit. During operation of the light-emitting unit, light (e.g., IR light) is emanated from the light exit region 133. The second electrode 132 and the light exit region 133 exposed from the front side of the second plastic encapsulation layer 110. At least part of the surface of the electrical conduction element 140 close to the back side of the second plastic encapsulation layer 110 is exposed from the back side of the second plastic encapsulation layer 110.

With continued reference to FIG. 1, a plurality of through holes 150 are provided in the second plastic encapsulation layer 110. The through holes 150 extend through the front side and the back side of the second plastic encapsulation layer 110 in the thickness direction. Moreover, a conductive material is filled in the plurality of through holes 150. The conductive material is filled in the through holes 150 in order to connect circuitry on the front side of the second plastic encapsulation layer 110 to circuitry on the back side of the second plastic encapsulation layer 110.

The conductive material is, for example, a conductive metal such as copper (Cu), tungsten (W), silver (Ag) or gold (Au), a conductive alloy or a conductive paste.

A first structure is formed on the front side of the second plastic encapsulation layer 110. The first structure on the front side of the second plastic encapsulation layer 110 is electrically connected to the conductive material in the through holes 150, as well as to both the first electrode 131 in the light-emitting device 130 and the input/output port 122 in the driver chip 120. The first structure includes a first passivation layer 210, a first metal layer 220 and a second passivation layer 230, which are formed over the front side of the second plastic encapsulation layer 110 sequentially in this order. The first passivation layer 210 covers the front side of the second plastic encapsulation layer 110 and the front side of the driver chip 120 in such a manner that the input/output port 122 and the photosensitive member 123 in the driver chip 120, the second electrode 132 and the light exit region 133 in the light-emitting device 130 and part of the front side of the second plastic encapsulation layer 110 are exposed from the first passivation layer 210, and that the conductive material in the through holes 150 is exposed from the front side of the second plastic encapsulation layer 110. The first metal layer 220 includes a plurality of first bonding pads disposed on parts of the first passivation layer 210. These first bonding pads are electrically connected to the input/output port 122, the conductive material in the through holes 150 and the second electrode 132.

The second passivation layer 230 covers the first passivation layer 210 and the first metal layer 220. The first passivation layer 210 and the second passivation layer 230 are adapted for electrical isolation of the first metal layer 220 and avoidance of a short circuit. The photosensitive member 123 in the driver chip 120 and the light exit region 133 in the light-emitting device 130 are exposed from the second passivation layer 230.

The first passivation layer 210 and the second passivation layer 230 are insulating materials such as polymer materials. Examples of these include one or a combination of several of polyimide (PI), benzocyclobutene (BCB) and poly(p-phenylenebenzobisoxazole) (PBO). The materials of the first passivation layer 210 and the second passivation layer 230 may be either identical or different. In this embodiment, the first passivation layer 210 and the second passivation layer 230 are formed of the same material such as PI.

The first metal layer 220 may be a metal material such as Cu, Ag, W or Au, a conductive alloy, an inorganic material such as a conductive oxide (e.g., ITO), or a conductive organic material such as a conductive polymer. A thickness of the first metal layer 220 above a surface of the first passivation layer 210 is approximately between 3 μm and 10 μm, preferably between 3 μm and 5 μm.

A second structure is formed on the back side of the second plastic encapsulation layer 110. The second structure on the back side of the second plastic encapsulation layer 110 is electrically connected to the conductive material in the through holes 150 and the electrical conduction element 140. The second structure includes a third passivation layer 240, a second metal layer 250 and a fourth passivation layer 260, which are formed over the back side of the second plastic encapsulation layer 110 sequentially in this order. The third passivation layer 240 covers the back side of the second plastic encapsulation layer 110 and the back side of the driver chip 120 in such a manner that part of the back side of the light-emitting unit is exposed from the third passivation layer 240 and that the conductive material in the through holes are exposed from the back side of the second plastic encapsulation layer 110. Specifically, the third passivation layer 240 covers the back side of the second plastic encapsulation layer 110 and the surface of the main body 121 away from the photosensitive member 123 in such a manner that part of a surface of the electrical conduction element 140 in the light-emitting unit away from the front side of the second plastic encapsulation layer 110 is exposed from the third passivation layer 240 and that the conductive material in the through holes is exposed from the back side of the second plastic encapsulation layer 110.

The second metal layer 250 includes a plurality of second bonding pads disposed on parts of the third passivation layer 240. These second bonding pads are electrically connected to the conductive material in the through holes 150 and to the electrical conduction element 140. It is to be noted that the conductive material in the through holes 150 electrically connected to the second metal layer 250 may be further electrically connected to the electrical conduction element 140 or not, as practically required.

The fourth passivation layer 260 covers the third passivation layer 240 and the second metal layer 250. The third passivation layer 240 and the fourth passivation layer 260 are adapted for electrical isolation of the second metal layer 250 and avoidance of a short circuit.

At least two connecting holes 270 are formed in the fourth passivation layer 260. The second metal layer 250 is exposed in the at least two connecting holes 270. A conductive material is filled in the connecting holes 270. The conductive material in the connecting holes 270 is adapted to be electrically connected to external circuitry (e.g., a PCB or FPC).

The third passivation layer 240 and the fourth passivation layer 260 are insulating materials such as polymer materials. Examples of these include one or a combination of several of polyimide (PI), benzocyclobutene (BCB) and poly(p-phenylenebenzobisoxazole) (PBO). The materials of the first passivation layer 210, the second passivation layer 230, the third passivation layer 240 and the fourth passivation layer 260 may be either identical or different. In this embodiment, the third passivation layer 240 and the fourth passivation layer 260 are formed of the same material such as PI.

The second metal layer 250 may be a metal material such as Cu, Ag, W or Au, a conductive alloy, an inorganic material such as a conductive oxide (e.g., ITO), or a conductive organic material such as a conductive polymer. A thickness of the second metal layer 250 above a surface of the third passivation layer 240 is approximately between 3 μm and 10 μm, preferably between 3 μm and 5 μm.

According to this embodiment, the light-emitting unit and the driver chip in the light-emitting module are buried in the plastic encapsulation material (the second plastic encapsulation layer), and thin film wires (the first metal layer, the second metal layer and the conductive material in the through holes) are fabricated on the plastic encapsulation material. This enables the optical sensor device to have a reduced size, resulting in space savings.

FIG. 4 is a schematic diagram showing the structure of the optical filter structure according to an embodiment of the present invention. As shown in FIG. 4, the optical filter structure is adapted to filter out light signals at some wavelengths, such as visible light. It allows passage of only light signals from the light exit region and reflections of them from objects stricken by them. Wavelengths of light signals that are allowed to pass through the optical filter structure ranges from 780 nm to 1500 nm.

The optical filter structure includes embedded optical filters. Specifically, the optical filter structure includes a first plastic encapsulation layer 310, a first optical filter 320 and a second optical filter 330. Both the first optical filter 320 and the second optical filter 330 are embedded in the first plastic encapsulation layer 310. Both the first optical filter 320 and the second optical filter 330 are spaced apart from each other. Each of the first optical filter 320 and the second optical filter 330 has a front side and an opposing back side. The front and back sides of the first optical filter 320 and the front and back sides of the second optical filter 330 are all exposed from the first plastic encapsulation layer 310. The first optical filter 320 and the second optical filter 330 have different shapes and/or sizes with respect to a direction perpendicular to a thickness direction of the first plastic encapsulation layer 310.

The first optical filter 320 in the optical filter structure is disposed above the photosensitive member 123 in order to filter emitted light that is reflected by an object to the driver chip. The second optical filter 330 is disposed above the light exit region 133 in order to filter light emitted from the light-emitting unit. In this way, the first optical filter 320 and the second optical filter 330 can filter light during its passage through them.

The optical filter structure can be boned to a front side of the light-emitting module by the adhesive 340. The adhesive 340 is applied to the second passivation layer 230 and/or the second plastic encapsulation layer 110 in the light-emitting module and has a thickness ranging from 10 μm to 20 μm. In this way, the optical filter structure is spaced apart from the second passivation layer 230. According to this embodiment, bonding the optical filters embedded in the plastic encapsulation material to the light-emitting module can result in space savings.

In embodiments of the present invention, there is also provided a packaging method for an optical sensor device, which includes the steps as follows.

S1: Provide a first carrier substrate and a second carrier substrate. The first carrier substrate is provided on its one side with a first adhesive layer, and the second carrier substrate is provided on its one side with a second adhesive layer. The second and first carrier substrates are, for example, square or circular in shape. The second and first carrier substrates are both temporary carrier substrates.

S2: Place at least one first optical filter 320 and at least one second optical filter 330 on the first adhesive layer in such a manner that they are spaced apart from each other and place at least one light-emitting unit and at least one driver chip 120 on the second adhesive layer, with front sides of the light-emitting unit and of the driver chip 120 both facing the second adhesive layer. Both the light-emitting unit and the driver chip 120 have the front side and an opposing back side. The front sides of the light-emitting unit and the driver chip 120 are oriented to both face the second adhesive layer. The light-emitting unit has a light exit region 133 on its front side, and the driver chip 120 has a photosensitive member 123 on its front side.

S3: Fill a plastic encapsulation material between the first optical filter 320 and the second optical filter 330, cure the plastic encapsulation material to form a first plastic encapsulation layer 310, filling a plastic encapsulation material between the light-emitting unit and the driver chip 120 and cure the plastic encapsulation material to form a second plastic encapsulation layer 110. The second plastic encapsulation layer 110 has a front side and an opposing back side. The front sides of the second plastic encapsulation layer 110, the light-emitting unit and the driver chip 120 face the same direction, and the front and back sides of the light-emitting unit and the front side of the driver chip are exposed from the second plastic encapsulation layer 110.

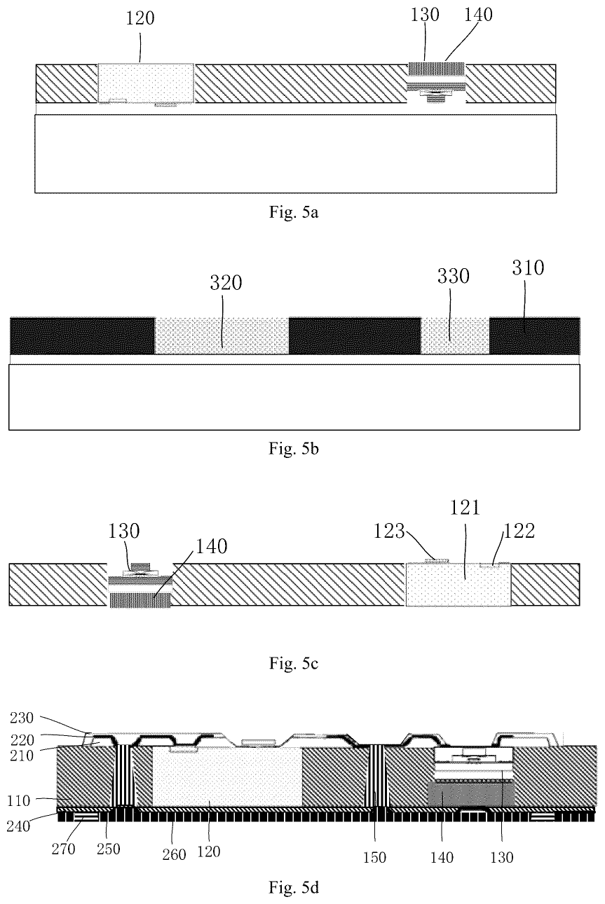

As shown in FIGS. 5a and 5b, in this embodiment, the front and back sides of the light-emitting unit and the front and back sides of the driver chip 120 are all exposed from the second plastic encapsulation layer 110.

S4: Remove the second carrier substrate and the first carrier substrate (as shown in FIGS. 5c and 4).

S5: Form, in the second plastic encapsulation layer 110, a plurality of through holes 150 extending through the second plastic encapsulation layer 110 in a thickness direction thereof, fill a conductive material in the through holes 150, form a first structure on the front side of the second plastic encapsulation layer 110, wherein the first structure is electrically connected on the front side of the second plastic encapsulation layer 110 to the conductive material in the through holes 150 and to both the light-emitting unit and the driver chip 120, and form a second structure on the back side of the second plastic encapsulation layer 110, wherein the second structure is electrically connected on the back side of the second plastic encapsulation layer 110 to the conductive material in the through holes 150 and to the light-emitting unit (as shown in FIG. 5d). Openings are formed in the first passivation layer 210 of the first structure, in which an input/output port 122 and a photosensitive member 123 in the driver chip 120 and a second electrode 132 and a light exit region 133 in the light-emitting device 130 are exposed. Openings are formed in the third passivation layer of the second structure, in which part of a surface of an electrical conduction element 140 away from the front side of the second plastic encapsulation layer 110 is exposed, and the conductive material in the through holes is exposed from a back side thereof. At least two connecting holes 270 are formed in a fourth passivation layer in the second structure. A second metal layer is exposed in the at least two connecting holes 270. Moreover, a nickel gold layer is plated, or a tin solder material is applied, at the at least two connecting holes 270, and welding to an external circuit is accomplished with the tin solder material.

S6: Bonding the first plastic encapsulation layer 310 to the front side of the second plastic encapsulation layer 110 so that the photosensitive member 123 is located under the first optical filter 320 and the light exit region 133 under the second optical filter 330 (as shown in FIG. 1).

In this step, the first plastic encapsulation layer 310 is bonded to the front side of the second plastic encapsulation layer 110 by using an adhesive 340. The adhesive 340 is applied to a designated location by screen printing, or by exposure using a photomask and subsequent development if it is a photosensitive material, or by another technique. The adhesive 340 may be applied to the second passivation layer 230 and/or to the second plastic encapsulation layer 110.

In this embodiment, the light-emitting module and the optical filter structure are formed simultaneously. However, in practice, the formation of the light-emitting module may precede the formation of the optical filter structure. Alternatively, the formation of the optical filter structure may precede the formation of the light-emitting module.

In summary, the present invention provides an optical filter structure, a packaging method for the optical filter structure, an optical sensor device and a packaging method for the optical sensor device, in which optical filters are embedded in a plastic encapsulation material and bonded to a light-emitting module, thereby resulting in space savings. Moreover, in the light-emitting module, a light-emitting unit and a driver chip are embedded in a plastic encapsulation material (second plastic encapsulation layer), and thin-film wires (a first metal layer, a second metal layer and a conductive material in through holes) are formed on the plastic encapsulation material. In this way, the optical sensor device is allowed to have a reduced size, which results in space savings.

It is to be noted that, as used herein, the terms “first”, “second” and the like are only meant to distinguish various components, elements, steps, etc. from each other rather than indicate logical or sequential orderings thereof, unless otherwise indicated or specified.

It is to be understood that while the invention has been described above with reference to preferred embodiments thereof, it is not limited to these embodiments. In light of the above teachings, any person familiar with the art may make many possible modifications and variations to the disclosed embodiments or adapt them into equivalent embodiments, without departing from the scope of the invention. Accordingly, it is intended that any and all simple variations, equivalent changes and modifications made to the foregoing embodiments based on the substantive disclosure of the invention without departing from the scope thereof fall within this scope.

What is claimed is:

1. A packaging method for an optical filter structure, comprising the steps of:
providing a first carrier substrate, one side of the first carrier substrate being provided with a first adhesive layer; placing at least one first optical filter and at least one second optical filter on the first adhesive layer in such a manner that the first optical filter and the second optical filter are spaced apart from each other; filling a plastic encapsulation material between the first optical filter and the second optical filter and curing the plastic encapsulation material to form a first plastic encapsulation layer, wherein opposing sides of the first optical filter and opposing sides of the second optical filter are exposed from the first plastic encapsulation layer; and removing the first carrier substrate.

2. A driver chip, configured to be embedded in a second plastic encapsulation layer, the second plastic encapsulation layer provided on a front side thereof with a first structure, the driver chip comprising a main body, an input/output port and a photosensitive member; the input/output port and the photosensitive member disposed on a same side, and spaced apart from each other on the main body, the main body disposed close to a back side of the second plastic encapsulation layer, both the input/output port and the photosensitive member disposed close to the front side of the second plastic encapsulation layer; wherein the input/output port and the photosensitive member in the driver chip are exposed from the front side of the second plastic encapsulation layer, thereby enabling the first structure to be electrically connected on the front side of the second plastic encapsulation layer to the input/output port.

3. An optical sensor device, comprising a light-emitting module and an optical filter structure,
the light-emitting module comprising a second plastic encapsulation layer, a light-emitting unit and the driver chip of claim 2, the light-emitting unit and the driver chip both embedded in the second plastic encapsulation layer, the light-emitting unit and the driver chip spaced apart from each other, each of the second plastic encapsulation layer, the light-emitting unit and the driver chip having a front side and a back side, the front sides of the second plastic encapsulation layer, the light-emitting unit and the driver chip facing a same direction, the light-emitting unit provided on the front side thereof with a light exit region, the front and back sides of the light-emitting unit and the front side of the driver chip exposed from the second plastic encapsulation layer, the second plastic encapsulation layer provided therein with a plurality of through holes, which extend in a thickness direction through the second plastic encapsulation layer, and in which a conductive material is filled, the second plastic encapsulation layer provided on the front side thereof with a first structure, the first structure electrically connected on the front side of the second plastic encapsulation layer to the conductive material in the through holes and to the light-emitting unit and the driver chip, the second plastic encapsulation layer provided on the back side thereof with a second structure, the second structure electrically connected on the back side of the second plastic encapsulation layer to the conductive material in the through holes and to the light-emitting unit, the optical filter structure bonded to a front side of the light-emitting module and comprising a first plastic encapsulation layer, a first optical filter and a second optical filter, the first optical filter and the second optical filter both embedded in the first plastic encapsulation layer, the first optical filter and the second optical filter spaced apart from each other, opposing sides of the first optical filter and opposing sides of the second optical filter exposed from the first plastic encapsulation layer, the second optical filter disposed above the light exit region and configured to filter light emanated from the light-emitting unit, the first optical filter disposed above the photosensitive member and configured to filter emitted light that is reflected by an object to the driver chip.

4. The optical sensor device of claim 3, wherein the first optical filter and the second optical filter have different shapes and/or sizes with respect to a direction perpendicular to a thickness direction of the first plastic encapsulation layer.

5. The optical sensor device of claim 3, wherein the second plastic encapsulation layer has a thickness equal to the thinnest thickness of the light-emitting unit and the driver chip.

6. The optical sensor device of claim 3, wherein the light-emitting unit comprises a light-emitting device and an electrical conduction element, the electrical conduction element electrically connected to the light-emitting device, the light-emitting device disposed close to the front side of the second plastic encapsulation layer, the electrical conduction element disposed close to the back side of the second plastic encapsulation layer.

7. The optical sensor device of claim 6, wherein the light-emitting device is a light-emitting diode or a vertical-cavity surface-emitting laser.

8. The optical sensor device of claim 6, wherein at least part of a surface of the light-emitting device close to the front side of the second plastic encapsulation layer is exposed from the front side of the second plastic encapsulation layer and at least part of a surface of the electrical conduction element close to the back side of the second plastic encapsulation layer is exposed from the back side of the second plastic encapsulation layer, thereby enabling the first structure to be electrically connected on the front side of the second plastic encapsulation layer to the light-emitting device and enabling the second structure to be electrically connected on the back side of the second plastic encapsulation layer to the electrical conduction element.

9. The optical sensor device of claim 6, wherein the light-emitting device comprises a light-emitting body, a first electrode, a second electrode and a light exit region, the first electrode disposed close to the back side of the second plastic encapsulation layer, the second electrode and the light exit region are disposed on the same side and both disposed close to the front side of the second plastic encapsulation layer.

10. The optical sensor device of claim 9, wherein the second electrode and the light exit region are exposed from the front side of the second plastic encapsulation layer, thereby enabling the first structure to be electrically connected on the front side of the second plastic encapsulation layer to the second electrode.

11. The optical sensor device of claim 6, wherein the electrical conduction element is electrically connected to the light-emitting device vertically by silver paste, thereby improving heat dissipation to the back side of the second plastic encapsulation layer.

12. The optical sensor device of claim 11, wherein the silver paste has a thickness of 50 μm.

13. The optical sensor device of claim 3, wherein the first structure comprises a first passivation layer, a first metal layer and a second passivation layer, which are formed over the front side of the second plastic encapsulation layer sequentially in this order, the first passivation layer covering the front side of the second plastic encapsulation layer and the front side of the driver chip in such a manner that the input/output port and the photosensitive member in the driver chip, the second electrode and the light exit region in the light-emitting unit and part of the front side of the second plastic encapsulation layer are exposed from the first passivation layer and that the conductive material in the through holes are exposed from the front side of the second plastic encapsulation layer.

14. The optical sensor device of claim 13, wherein the first metal layer comprises a plurality of first bonding pads, wherein the plurality of first bonding pads are located on parts of the first passivation layer and are electrically connected to the input/output port, the conductive material in the through holes and the second electrode in the light-emitting unit, and
the second passivation layer covering the first passivation layer and the first metal layer in such a manner that the photosensitive member and the light exit region are exposed from the second passivation layer.

15. The optical sensor device of claim 3, wherein the second structure comprises a third passivation layer, a second metal layer and a fourth passivation layer, which are formed over the back side of the second plastic encapsulation layer sequentially in this order,
the third passivation layer covering the back side of the second plastic encapsulation layer and the back side of the driver chip in such a manner that the back side of the light-emitting unit is exposed from the third passivation layer and that the conductive material in the through holes is exposed from the back side of the second plastic encapsulation layer,
the second metal layer comprising a plurality of second bonding pads, which are located on parts of the third passivation layer and are electrically connected to the conductive material in the through holes and the electrical conduction element in the light-emitting unit,
the fourth passivation layer covering the third passivation layer and the second metal layer, the fourth passivation layer provided therein with at least two connecting holes in which the second metal layer is exposed, the connecting holes filled with a conductive material, the conductive material in the connecting holes configured to be electrically connected to an external circuit.

16. A packaging method for the optical sensor device of claim 3, comprising the steps of:
providing a first carrier substrate and a second carrier substrate, one side of the first carrier substrate provided with a first adhesive layer, one side of the second carrier substrate provided with a second adhesive layer;
placing at least one first optical filter and at least one second optical filter on the first adhesive layer in such a manner that the first optical filter and the second optical filter are spaced apart from each other and placing at least one of the light-emitting unit and at least one of the driver chip on the second adhesive layer in such a manner that the light-emitting unit and the driver chip are spaced apart from each other, wherein each of the light-emitting unit and the driver chip has a front side and an opposing back side, wherein the front sides of the light-emitting unit and the driver chip are disposed on the same side and both face the second adhesive layer, and wherein the front side of the light-emitting unit is provided with the light exit region and the front side of the driver chip is provided with the photosensitive member;
filling a plastic encapsulation material between the first optical filter and the second optical filter, curing the plastic encapsulation material to form the first plastic encapsulation layer, filling a plastic encapsulation material between the light-emitting unit and the driver chip and curing the plastic encapsulation material to form the second plastic encapsulation layer, wherein the second plastic encapsulation layer has a front side and an opposing back side, wherein the front sides of the second plastic encapsulation layer, the light-emitting unit and the front side are disposed on the same side, and wherein the front and back sides of the light-emitting unit and the front side of the driver chip are exposed from the second plastic encapsulation layer;
removing the first carrier substrate and the second carrier substrate;
forming the second structure on the back side of the second plastic encapsulation layer, the second structure electrically connected on the back side of the second plastic encapsulation layer to both the conductive material in the through holes and the light-emitting unit, forming the plurality of through holes in the second plastic encapsulation layer, the plurality of through holes extending through the second plastic encapsulation layer in the thickness direction thereof, filling the conductive material in the through holes, and forming the first structure on the front side of the second plastic encapsulation layer, the first structure electrically connected on the front side of the second plastic encapsulation layer to the conductive material in the through holes, the light-emitting unit and the driver chip; and
bonding the first plastic encapsulation layer to the front side of the second plastic encapsulation layer in such a manner that the photosensitive member is located under the first optical filter and the light exit region under the second optical filter.
